(19) United States
(12) Patent Application Publication
(10) Pub. No.: US 2023/0376835 A1
(43) Pub. Date: Nov. 23, 2023

(54) DEEP ANGULAR SIMILARITY LEARNING

(71) Applicant: Microsoft Technology Licensing, LLC, Redmond, WA (US)

(72) Inventors: Itzik MALKIEL, Givaatayim (IL); Noam KOENIGSTEIN, Tel Aviv (IL); Yonathan WEILL, Tel Aviv (IL); Oren BARKAN, Reshon Lezion (IL); Jonathan EPHRATH, Tel Aviv (IL); Nir NICE, Salit (IL)

(21) Appl. No.: 17/749,701

(22) Filed: May 20, 2022

(51) Int. Cl. G06N 20/00

(52) U.S. Cl. CPC G06N 20/00

(57) ABSTRACT

A comparison engine performs item similarity comparisons. A source item and one or more candidate items are input into a triplet-trained machine learning model trained using training data including triplets of anchor elements, positive elements, and negative elements. Each triplet corresponds to an item included in the training data. The anchor elements and the positive elements are included in the corresponding item. The negative element is included in a different item in the training data. A similarity score between the source item and each of the one or more candidate items is generated from the triplet-trained machine learning model.

### BACKGROUND

Text, images, video, audio, and data of other formats can be rich sources of information, but extracting meaning from such unstructured data using computerized analysis can be challenging. One factor in extracting meaning from such data involves classification, which involves determining similarity between different data items. For example, when searching for results responsive to a search query, the terms of the search query are compared to indexed terms extracted from documents in the data to be searched. Generally, documents containing more terms that are similar to terms in the search query will likely be ranked higher than other documents, although many different text classification algorithms may be employed.

Various rule-based and machine-learning-based approaches have been applied to text classification, with varying degrees of success. However, the accuracy of such text classification approaches is often inadequate for many applications and environments.

### SUMMARY

The described technology provides item similarity comparisons. A source item and one or more candidate items are input into a triplet-trained machine learning model trained using training data including triplets of anchor elements, positive elements, and negative elements. Each triplet corresponds to an item included in the training data. The anchor elements and the positive elements are included in the corresponding item. The negative element is included in a different item in the training data. A similarity score between the source item and each of the one or more candidate items is generated from the triplet-trained machine learning model.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates a search engine with a comparison engine employing textual item similarity based on a machine learning model trained by self-supervised triplet training.

FIG. 2 illustrates example self-supervised triplet training of a machine learning model of a comparison engine.

FIG. 3 illustrates an example training flow for self-supervised triplet training of a machine learning model.

FIG. 4 illustrates example operations for self-supervised triplet training of a machine learning model.

FIG. 5 illustrates example operations for self-supervised triplet training of a machine learning model.

FIG. 6 illustrates example hardware and software that can be useful in implementing the described technology.

### DETAILED DESCRIPTIONS

Learning textual similarity is a long-standing task with applications in information retrieval, search engines, document clustering, essay scoring, and recommender systems. In the described technology, a self-supervised machine learning model for text similarity employs a metric learning technique, utilizing pseudo-labels of negative and positive text passages (e.g., type of text elements) extracted from the dataset at hand. The pseudo-labels serve as a proxy to the ultimate (but absent) similarity labels.

Although the description herein focuses on textual similarity, the described technology is also applicable to other data formats, including without limitation video, audio, images, and combinations thereof. For example, while textual item similarity may be addressed by selecting elements of text associated with an item and inputting the elements through a machine learning model trained on text, similarity can also be computed between images, videos, audio, etc. associated with different items by machine learning models trained on those data formats. Once the elements are vectorized (e.g., embedded in a vector space by an appropriately trained model), a similarity score may be computed between given vectors in the vector space, as the vectors can be data-format-agnostic.

In the case of a search engine or recommendation system, example textual items could include without limitation products, services, movies, songs, topics, etc. that correspond to a textual description in a database or catalog. Each textual item may be associated with text, such as an item title, an item description, etc. For example, the movie “Apollo 13” and its associated description, summary, and/or review text may be considered one or more textual items. As such, a search engine may search for other textual items relating to the “Apollo 13,” such as other movies about the space program. In an alternative implementation, a user may have already watched “Apollo 13” and given it a “thumbs up,” and a recommendation system may then use the textual item of “Apollo 13” to recommend other movies to the user, such as movies including Tom Hanks. As such, item-to-item similarity is used by a comparison engine to rank and present other movies that are similar to “Apollo 13.”

The described technology jointly optimizes a masked-language machine learning model and a margin-based triplet (metric learning) loss. The metric learning strives to embed (e.g., in a vector space) similar samples closer to each other compared to dissimilar ones. Triplets of textual elements are propagated through the machine learning model during training, which separately embeds their tokens. In one aspect, the described technology evaluates similarity between two textual items using machine learning and a metric loss function/embedding that reduces or minimizes the angle between the vectors corresponding to two similar textual items as compared to two less similar textual items.

The embedded tokens of each text element are (1) fed into a masked language model loss and (2) pooled into a single vector. The pooled three vectors are applied through a metric-based loss function, such as a triplet loss function [symbol] _{T}. In one implementation, for example, metric learning is an approach based directly on a distance metric that aims to establish similarity or dissimilarity between data elements, such as text, images, audio, video, and other data formats. The metric (e.g., an angular distance metric, a distance metric) is used to judge the performance/accuracy of the machine learning model. A metric-based loss function, therefore, defines loss as a function of the metric (an angular distance metric relating to the triplets in at least one implementation of the described technology). Additionally, the described technology can leverage a hard negative mining procedure to accelerate convergence and improve performance. The total loss objective is represented by Lₜₒₜₐₗ=L_{MLM}+λL_{T}, where λ is a balancing hyper-parameter.

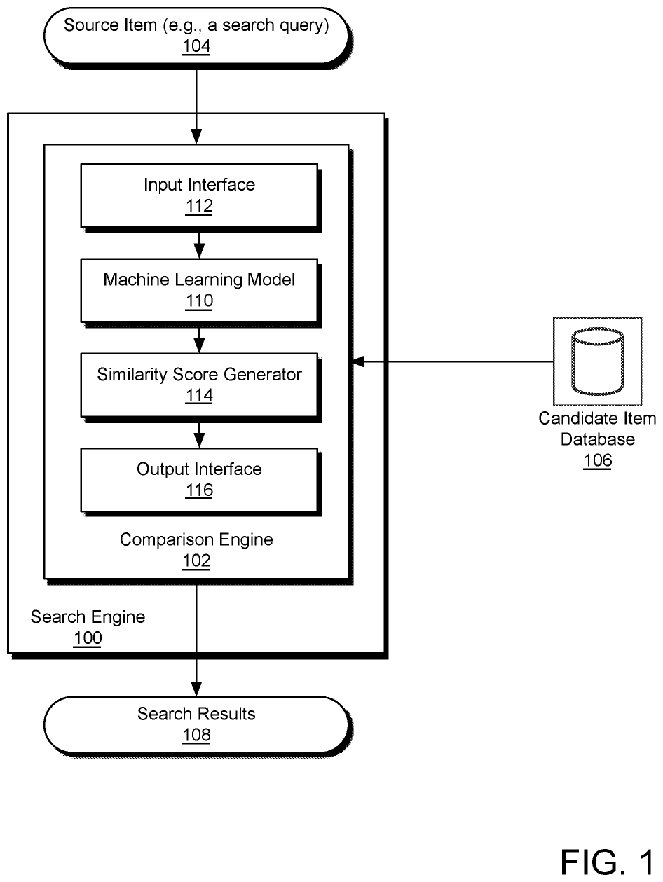

FIG. 1 illustrates a search engine 100 with a comparison engine 102 employing textual item similarity based on a machine learning model trained by self-supervised triplet training. In FIG. 1, a source item 104, such as a search query) is input to the search engine 100 for use in searching a candidate item database 106. Such a search involves textual item similarity scoring, a challenging operation that can nevertheless be useful in other applications as well, including without limitation information retrieval, document clustering, essay scoring, recommender systems, semantic processing, spam filtering, intrusion detection, and text and speech translation between different languages. In the case of a search engine, the textual item similarity scoring may be employed to categorize and organize and rank data efficiently during the search. Categorization is accomplished based at least in part on comparing the search query keywords to related keywords in the searched data. Using this training, the machine learning model 110 is trained to evaluate the similarity between two textual items using machine learning using a metric loss function/embedding that reduces or minimizes the angle between the vectors corresponding to two similar textual items as compared to two less similar textual items.

In the illustrated search engine 100, the comparison engine 102 performs textual item similarity scoring using a machine learning model 110 that has been trained by self-supervised triplet training. During training, the machine learning model 110 is trained using self-supervised triplet training in which triplets of textual elements (xₐ, xₚ, xₙ), where xₐ, xₚ, xₙ, are anchor, positive, and negative samples, respectively. The triplets are input through an input interface 112 of the comparison engine 102, such as an application programming interface or API, shared memory, etc. Each anchor and positive sample are textual elements associated with the same item p∈D, where D:={(aᵢ, bᵢ)ᵢ₌₁^{N}} defines a dataset of N items, and each item is a pair of two contextual elements. For example, the text element samples for xₐ and xₚ are taken from the “Apollo 13” textual item. Given a source item s∈D, the task is to rank all the other items in D according to their semantic similarity to s. In contrast, each text element sample for xₙ, are taken from a different, randomly sampled textual item n∈D (e.g., not from the “Apollo 13” textual item).

In other implementations, video, images, audio, and other formats of data associated with the items may also be trained into corresponding machine learning models (e.g., an image-trained model, an audio-trained model). These format-trained models can be used to embed elements of different data formats into the same vector space. While elements from text data may be sampled in the form of words and/or strings, samples for other data formats can be similarity extracted and masked. For example, portions of a video (e.g., different frames or frame sequences, different patches of pixels), an image (e.g., different patches of pixels), and/or an audio clip (e.g., different segments of the audio clip) may be sampled as elements for each type of format. Then, anchor, positive, and negative elements of these samples may be selected during training of the corresponding format-trained models. Likewise, samples of non-training data of any of these data formats may be similarly extracted for use with the corresponding format-trained models during inference.

During inference, the machine learning model 110 inputs two text strings (e.g., one string from the source item 104 and the other string from the candidate item database 106), and a similarity score generate 114 generates a similarity score indicating a similarity between the two text strings. A large number of such comparisons are made between strings of the source item 104 and strings in the candidate item database 106. Similarity scores for individual strings of an individual document in the candidate item database 106 are aggregated into a similarity for the document, and the aggregated scores for the documents of the candidate item database 106 are ranked to provide a ranked set of search results 108 (e.g., the highest-ranked documents are computed to have the highest similarity to the source item 104 and are therefore expected to be more relevant to the source item 104). As such, based on the scoring of the textual item similarity performed by the comparison engine 102, the search engine 100 outputs the search results 108 (e.g., a ranked listing of documents containing similar strings from the candidate item database 106) through an output interface 116, such as an application programming interface or API, shared memory, etc.

A similar process may be used for other data formats using format-trained models for each format. Once embedded in the vector space, the vectors representing each element (e.g., of any format) may be compared according to a metric-based loss function, such as a loss function using an angular distance metric between two vectors.

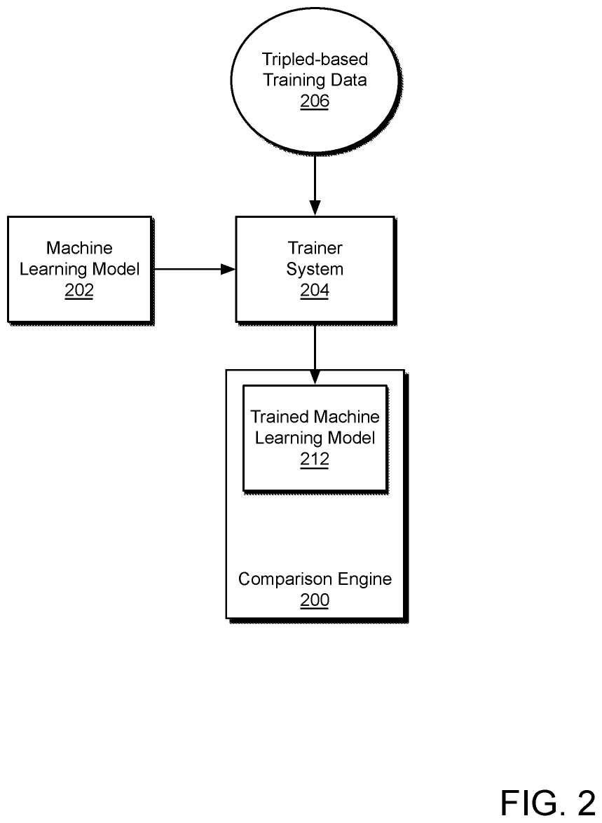

FIG. 2 illustrates example self-supervised triplet training of a machine learning model of a comparison engine 200. A machine learning model 202 is trained by a trainer system 204 using triplet-based training data 206 that includes triplets of textual elements (xₐ, xₚ, xₙ), where xₐ, xₚ, xₙ, are anchor, positive, and negative samples, respectively. The resulting trained machine learning model 212 is then used by the comparison engine 200 during inference to generate similarities scores between different textual items.

The trainer system 204 uses the triplet-based training data 206 to generate the trained machine learning model 212 (an ML model). Training an ML model means determining good values for the weights and the bias in the ML algorithm from labeled examples, which constitute the training data. In self-supervised learning, for example, a machine learning algorithm trains a model by examining many examples of labeled data and attempting to find a model that minimizes loss, a process called empirical risk minimization. Other training approaches may be employed. As shown in FIG. 2, the trainer system 204 trains the machine learning model 202 using triplet-based training data 206, thereby resulting in a trained machine learning model 212.

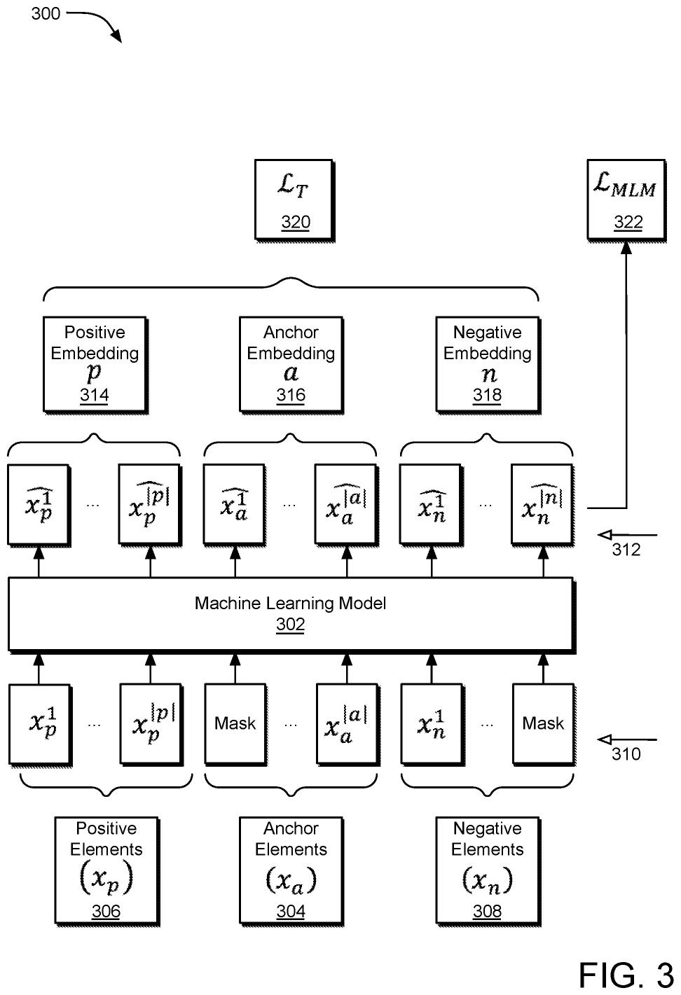

FIG. 3 illustrates an example training flow 300 for self-supervised triplet training of a machine learning model. As described above, D:={(aᵢ, bᵢ)ᵢ₌₁^{N}} defines a dataset of N items, where each item i is a pair of two textual elements. Given a source item s∈D, the task is to rank all the other items in D according to their semantic similarity to s. Again, while the description herein focuses primarily on textual data formats (and combinations thereof), the described technology may be applied to text, images, video, audio, and/or other data formats using machine learning models for each corresponding format.

In one implementation, training is initialized with a pre-trained machine learning model 302, such as a BERT (Bidirectional Encoder Representations from Transformers) model. BERT is a transformer-based machine technique for natural language processing. The training proceeds using input triplets of textual elements (xₐ, xₚ, xₙ) where xₐ, xₚ, and xₙ, are anchor elements 304, positive elements 306, and negative elements 308, respectively. Each anchor and positive sample are textual elements associated with the same item p∈D, where D:={(aᵢ, bᵢ)ᵢ₌₁^{N}} defines a dataset of N items, and each item is a pair of two contextual elements. Given a source item s∈D, the task is to rank all the other items in D according to their semantic similarity to s. In contrast, each text element sample for xₙ, is taken from a different, randomly sampled textual item n∈D.

The textual elements are separately tokenized and masked in level 310 of the training flow 300, aggregated over the batch dimension, and propagated through the machine learning model 302. The embeddings of each of the three elements are used to train the machine learning model 302 to (1) rank the positive and negative samples, based on the anchor text, and to (2) reconstruct the masked words in each element. These objectives may be obtained by minimizing a combination of a triplet-loss L_{T}, and a standard masked language loss denoted by L_{MLM}. The triplet loss L_{T} (triple loss 320) is defined by:

L_{T}=L(a,p,n)=max(0,m+d(a,p)−d(a,n)), (1)

where m is a pre-defined margin, a, p, and n are the anchor embeddings 314, the positive embeddings 316, and the negative embeddings 318 generated from level 312 of the training flow 300:

a=f(xₐ),p=f(xₚ),n=f(xₙ), (2)

and d is the angular distance between two element vectors u and v, which can be expressed as:

d(u,v)=arccos(C(u,v))/π, (3)

where u, v∈ [symbol] ^{d} are d-dimensional vectors and C is the cosine similarity:

$$C ( u , v ) = \frac{u \cdot v}{‖ u ‖ ‖ v ‖} . \qquad ( 4 )$$

The choice of the angular distance over a standard cosine similarity stems from empirical observations that optimizing a cosine similarity results in a sizeable degradation in performance, where the model “collapses” into a narrow manifold (e.g., the embedding of all items in the dataset retrieved a cosine similarity that approaches one), although other similarity functions may be employed. This improved performance of the angular distance can be attributed to its enhanced sensitivity to micro-differences in the angle between vectors with similar directions.

The improved sensitivity of the angular distance is also apparent in the derivatives of the two metrics. While the derivative of the cosine distance is:

$$\frac{\partial }{\partial u} C ( u , v ) = \frac{v}{‖ u ‖ ‖ v ‖} - C ( u , v ) \cdot \frac{u}{{‖ u ‖}^{2}} , \qquad ( 5 )$$

the angular distance derivative can be expressed as:

$$\frac{\partial }{\partial u} d ( u , v ) = - \frac{1}{π \sqrt{1 - {( C ( u , v ) )}^{2}}} \frac{\partial }{\partial u} C ( u , v ) , \qquad ( 6 )$$

for which, compared to the cosine derivative, the denominator dynamically scales the gradients by an inverse ratio of the cosine distance between the vectors. In other words, compared to the cosine similarity, the angular distance yields gradients of larger magnitude for vectors with similar directions.

The total loss of machine learning model 302 is defined as:

Lₜₒₜₐₗ=L_{MLM}+λL_{T}, (7)

where λ, is a balancing hyper-parameter and the masked language model loss L_{MLM} (masked language model loss 322), which utilizes a classifier that projects the embedding of the masked elements to the vocabulary space, applies a softmax function to infer pseudo-probabilities and standard classification loss to optimize the machine learning model 302 to recover each of the masked elements. During at least one phase of the training, numerous sets of anchor, positive, and negative elements are input to the machine learning model 302. With each iteration, the training system adjusts the weights in the machine learning model 302 to reduce or minimize the Lₜₒₜₐₗ loss.

In at least one implementation, the machine learning model 302 also constructs triplets by associating each anchor-positive pair with the hardest negative sample in a given batch. More specifically, given an anchor-positive pair, the angular distance between the anchor element vectors and all the other element vectors in the batch is calculated (neglecting the “positive” element vector associated with the anchor vector). Next, the element vector with the smallest distance from the anchor element vector is selected as the negative sample. This technique allows the optimization to focus on the miss-matched elements that “confuse” the model the most, retrieve more triplets that violate the margin, and enhance the gradients of the triplet loss term.

When the machine learning model 302 is trained based on the triplets, the machine learning model 302 may be used in an inference operation to determine textual item similarity. Given a source and candidate items s: =(xᵢ, yᵢ), c:=(xⱼ, yⱼ), the textual item similarity is scored by:

SimilarityScore(s,c)=d(xᵢ,xⱼ)+d(yᵢ,yⱼ)

where d is the angular distance.

The sources represents a known textual item, such as an identified subject of a search query. For example, a search query may include “Apollo 13” and other descriptive text. In contrast, a candidate item c represents textual items against which the source is compared to yield a similarity score. The candidate item ranking can then be obtained by sorting (e.g., in ascending order) all candidate items according to their similarity score with s.

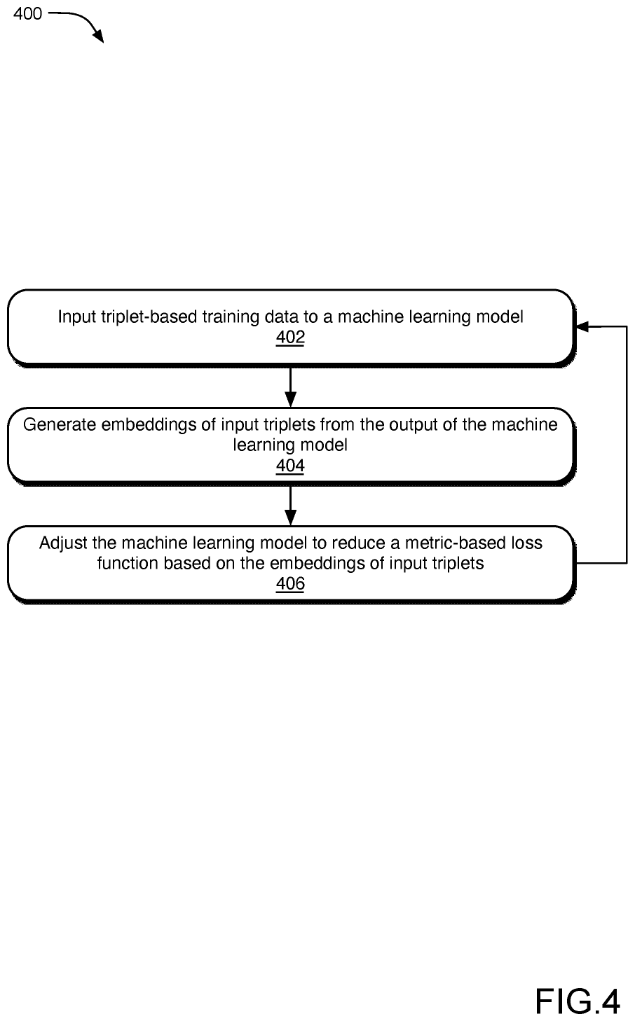

FIG. 4 illustrates example operations 400 for self-supervised triplet training of a machine learning model. In at least one implementation, the machine learning model is initialized as a pre-trained BERT model. While the description herein focuses primarily on textual data formats (and combinations thereof), the described technology may be applied to text, images, video, audio, and/or other data formats using machine learning models for each corresponding format.

An inputting operation 402 inputs triplet-based training data to the machine learning model. The triplet-based training data includes triplets of textual elements (xₐ, xₚ, xₙ) where xₐ, xₚ, and xᵢ, are anchor elements, positive elements, and negative elements, respectively. Each anchor and positive sample are textual elements associated with the same item p∈D, where D:={(aᵢ, bᵢ)ᵢ₌₁^{N}} defines a dataset of N items, and each item is a pair of two contextual elements. Given a source item s∈D, the task is to rank all the other items in D according to their semantic similarity to s. In contrast, each text element samples for xₙ, are taken from a different, randomly sampled item n∈D.

From the output of the machine learning model, a generating operation 404 generates embeddings for the input triplets (of anchors, positives, and negatives) representing vectors for each textual element in a vector space. A model training operation 406 adjusts the machine learning model to reduce, which may result in minimization or optimization of a metric-based loss function, which may be composed of an angular similarity applied to the embeddings of the triplets. In one implementation, the adjustment includes adjusting weights and/or biases, which are the learnable parameters of a machine learning model, including a neural network. The operations 400 typically iterates through the training data many times (e.g., for millions of iterations) to properly train the machine learning model.

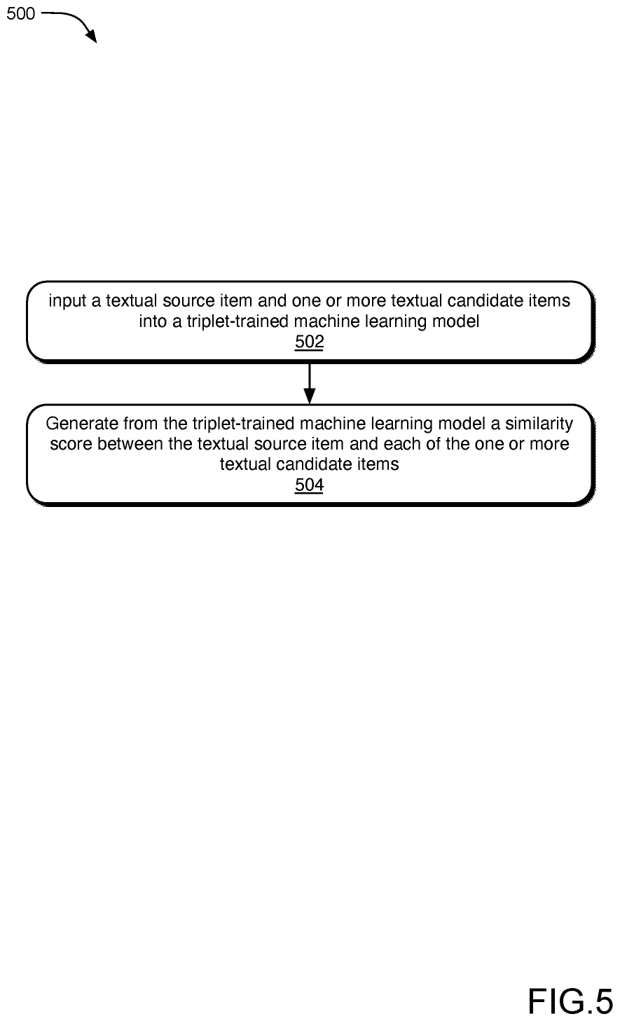

FIG. 5 illustrates example operations 500 for inference using a machine learning model trained using self-supervised triplet training. Again, while the description herein focuses primarily on textual data formats (and combinations thereof), the described technology may be applied to text, images, video, audio, and/or other data formats using machine learning models for each corresponding format.

An inputting operation 502 inputs a textual source item and one or more textual candidate items into a triplet-trained machine learning model, which has been trained using triplet-based training data that includes triplets of textual elements (xₐ, xₚ, xₙ) where xₐ, xₚ, and xₙ, are anchor elements, positive elements, and negative elements, respectively. Each anchor and positive sample are textual elements associated with the same item p∈D, where D:={(aᵢ, bᵢ)ᵢ₌₁^{N}} defines a dataset of N items, and each item is a pair of two contextual elements. Given a source item s∈D, the task is to rank all the other items in D according to their semantic similarity to s. In contrast, each text element samples for xₙ, are taken from a different, randomly sampled item n∈D.

When the machine learning model has been trained based on the triplets, the machine learning model may be used in an inference operation to determine textual item similarity. A generating operation 504 generates a similarity score between a source item and one or more candidate items. In one implementation, given a source and candidate items s: =(aᵢ, bᵢ), c: =(aⱼ, bⱼ), the textual item similarity is scored by:

SimilarityScore(s,c)=d(aᵢ,aⱼ)+d(bᵢ,bⱼ)

where d is the angular distance, which can be expressed as:

d(u,v)=arccos(C(u,v))/π.

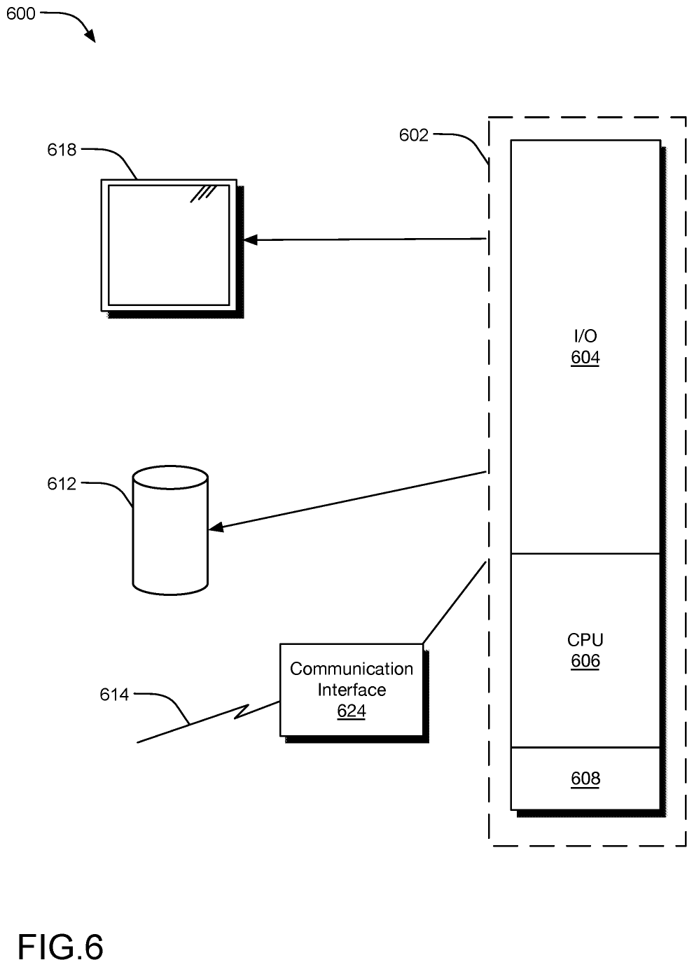

FIG. 6 illustrates an example computing device 600 for implementing the features and operations of the described technology. The computing device 600 may embody a remote control device or a physical controlled device and is an example network-connected and/or network-capable device and may be a client device, such as a laptop, mobile device, desktop, tablet; a server/cloud device; an internet-of-things device; an electronic accessory; or another electronic device. The computing device 600 includes one or more processor(s) 602 and a memory 604. The memory 604 generally includes both volatile memory (e.g., RAM) and nonvolatile memory (e.g., flash memory). An operating system 610 resides in the memory 604 and is executed by the processor(s) 602.

In an example computing device 600, as shown in FIG. 6, one or more modules or segments, such as applications 650, an input interface, an output interface, a machine learning model, a similarity score generator, a comparison engine, a search engine, a recommendation system, and other services, workloads, and modules, are loaded into the operating system 610 on the memory 604 and/or storage 620 and executed by processor(s) 602. The storage 620 may include one or more tangible storage media devices and may store source textual items, candidate textual items, search results, similarity scores, triple-based training data, and other data and be local to the computing device 600 or may be remote and communicatively connected to the computing device 600.

The computing device 600 includes a power supply 616, which is powered by one or more batteries or other power sources and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers and/or client devices (e.g., mobile devices, desktop computers, or laptop computers). The computing device 600 may further include a network adapter 636, which is a type of computing device. The computing device 600 may use the adapter and any other types of computing devices for establishing connections over a wide-area network (WAN) or local-area network (LAN). It should be appreciated that the network connections shown are exemplary and that other computing devices and means for establishing a communications link between the computing device 600 and other devices may be used.

The computing device 600 may include one or more input devices 634 such that a user may enter commands and information (e.g., a keyboard or mouse). These and other input devices may be coupled to the server by one or more interfaces 638, such as a serial port interface, parallel port, or universal serial bus (USB). The computing device 600 may further include a display 622, such as a touch screen display.

The computing device 600 may include a variety of tangible processor-readable storage media and intangible processor-readable communication signals. Tangible processor-readable storage can be embodied by any available media that can be accessed by the computing device 600 and includes both volatile and nonvolatile storage media, removable and non-removable storage media. Tangible processor-readable storage media excludes communications signals (e.g., signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Various software components described herein are executable by one or more processors, which may include logic machines configured to execute hardware or firmware instructions. For example, the processors may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Aspects of processors and storage may be integrated together into one or more hardware logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of a remote control device and/or a physical controlled device 802 implemented to perform a particular function. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service,” as used herein, is an application program executable across one or multiple user sessions. A service may be available to one or more system components, programs, and/or other services. In some implementations, a service may run on one or more server computing devices.

An example method of determining item similarity includes inputting a source item and one or more candidate items into a triplet-trained machine learning model trained using training data including triplets of anchor elements, positive elements, and negative elements, wherein each triplet corresponds to an item included in the training data, the anchor elements and the positive elements are included in the corresponding item, and the negative element is included in a different item in the training data. The method also includes generating from the triplet-trained machine learning model a similarity score between the source item and each of the one or more candidate items.

Another example method of any preceding method is provided, wherein the triplet-trained machine learning model is trained based on reducing a combination of a masked language model loss function and a metric-based loss function during training using the training data.

Another example method of any preceding method is provided, wherein the triplet-trained machine learning model is trained based on a metric-based loss function during training using the training data.

Another example method of any preceding method is provided, wherein the metric-based loss function is based on an angular distance between an embedded anchor element vector and an embedded positive element vector.

Another example method of any preceding method is provided, wherein the metric-based loss function is based on an angular distance between an embedded anchor element vector and an embedded negative element vector.

Another example method of any preceding method is provided, wherein the metric-based loss function is based on a first angular distance between an embedded anchor element vector and an embedded negative element vector subtracted from a second angular distance between the embedded anchor element vector and an embedded positive element vector.

Another example method of any preceding method is provided, further including training the triplet-trained machine learning model trained using the training data that includes triplets of anchor elements, positive elements, and negative elements.

An example comparison engine for determining item similarity includes one or more hardware processors and a triplet-trained machine learning model executable by the one or more hardware processors and trained using training data including triplets of anchor elements, positive elements, and negative elements, wherein each triplet corresponds to an item included in the training data, the anchor elements and the positive elements are included in the corresponding item, and the negative element is included in a different item in the training data. The comparison engine also includes an input interface executable by the one or more hardware processors and configured to input a source item and one or more candidate items into the triplet-trained machine learning model and a similarity score generator executable by the one or more hardware processors and configured to generate from the triplet-trained machine learning model a similarity score between the source item and each of the one or more candidate items.

Another example comparison engine of any preceding comparison engine is provided, wherein the triplet-trained machine learning model is trained based on a masked language model loss function during training using the training data.

Another example comparison engine of any preceding comparison engine is provided, wherein the triplet-trained machine learning model is trained based on a combination of a masked language model loss function and a metric-based loss function during training using the training data.

Another example comparison engine of any preceding comparison engine is provided, wherein the triplet-trained machine learning model is trained based on a metric-based loss function during training using the training data.

Another example comparison engine of any preceding comparison engine is provided, wherein the metric-based loss function is based on an angular distance between an embedded anchor element vector and an embedded positive element vector.

Another example comparison engine of any preceding comparison engine is provided, wherein the metric-based loss function is based on an angular distance between an embedded anchor element vector and an embedded negative element vector.

Another example comparison engine of any preceding comparison engine is provided, wherein the metric-based loss function is based on an angular distance between an embedded anchor element vector and an embedded negative element vector subtracted from an angular distance between the embedded anchor element vector and an embedded positive element vector.

One or more example tangible processor-readable storage media of a tangible article of manufacture encoding processor-executable instructions for executing a computing process for determining item similarity is provided. The computing process includes inputting a source item and one or more candidate items into a triplet-trained machine learning model trained using training data including triplets of anchor elements, positive elements, and negative elements, wherein each triplet corresponds to an item included in the training data, the anchor elements and the positive elements are included in the corresponding item, and the negative element is included in a different item in the training data. The computing process also includes generating from the triplet-trained machine learning model a similarity score between the source item and each of the one or more candidate items.

Another one or more example tangible processor-readable storage media of any preceding medial is provided, wherein the triplet-trained machine learning model is trained based on a combination of a masked language model loss function and a metric-based loss function during training using the training data.

Another one or more example tangible processor-readable storage media of any preceding medial is provided, wherein the triplet-trained machine learning model is trained based on a metric-based loss function during training using the training data.

Another one or more example tangible processor-readable storage media of any preceding medial is provided, wherein the metric-based loss function is based on an angular distance between an embedded anchor element vector and an embedded positive element vector.

Another one or more example tangible processor-readable storage media of any preceding medial is provided, wherein the metric-based loss function is based on an angular distance between an embedded anchor element vector and an embedded negative element vector.

Another one or more example tangible processor-readable storage media of any preceding medial is provided, wherein the metric-based loss function is based on an angular distance between an embedded anchor element vector and an embedded negative element vector subtracted from an angular distance between the embedded anchor element vector and an embedded positive element vector.

An example system of determining item similarity includes means for inputting a source item and one or more candidate items into a triplet-trained machine learning model trained using training data including triplets of anchor elements, positive elements, and negative elements, wherein each triplet corresponds to an item included in the training data, the anchor elements and the positive elements are included in the corresponding item, and the negative element is included in a different item in the training data. The method also includes means for generating from the triplet-trained machine learning model a similarity score between the source item and each of the one or more candidate items.

Another example system of any preceding system is provided, wherein the triplet-trained machine learning model is trained based on reducing a combination of a masked language model loss function and a metric-based loss function during training using the training data.

Another example system of any preceding system is provided, wherein the triplet-trained machine learning model is trained based on a metric-based loss function during training using the training data.

Another example system of any preceding system is provided, wherein the metric-based loss function is based on an angular distance between an embedded anchor element vector and an embedded positive element vector.

Another example system of any preceding system is provided, wherein the metric-based loss function is based on an angular distance between an embedded anchor element vector and an embedded negative element vector.

Another example system of any preceding system is provided, wherein the metric-based loss function is based on a first angular distance between an embedded anchor element vector and an embedded negative element vector subtracted from a second angular distance between the embedded anchor element vector and an embedded positive element vector.

Another example system of any preceding system is provided, further including means for training the triplet-trained machine learning model trained using the training data that includes triplets of anchor elements, positive elements, and negative elements.

While this specification contains many specific implementation details, these should not be construed as limitations on the scope of any inventions or of what may be claimed, but rather as descriptions of features specific to particular embodiments of a particular described technology. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A method of determining item similarity, the method comprising:
inputting a source item and one or more candidate items into a triplet-trained machine learning model trained using training data including triplets of anchor elements, positive elements, and negative elements, wherein each triplet corresponds to an item included in the training data, the anchor elements and the positive elements are included in the corresponding item, and the negative element is included in a different item in the training data; and
generating from the triplet-trained machine learning model a similarity score between the source item and each of the one or more candidate items.

2. The method of claim 1, wherein the triplet-trained machine learning model is trained based on reducing a combination of a masked language model loss function and a metric-based loss function during training using the training data.

3. The method of claim 1, wherein the triplet-trained machine learning model is trained based on a metric-based loss function during training using the training data.

4. The method of claim 3, wherein the metric-based loss function is based on an angular distance between an embedded anchor element vector and an embedded positive element vector.

5. The method of claim 3, wherein the metric-based loss function is based on an angular distance between an embedded anchor element vector and an embedded negative element vector.

6. The method of claim 3, wherein the metric-based loss function is based on a first angular distance between an embedded anchor element vector and an embedded negative element vector subtracted from a second angular distance between the embedded anchor element vector and an embedded positive element vector.

7. The method of claim 1, further comprising:
training the triplet-trained machine learning model trained using the training data that includes triplets of anchor elements, positive elements, and negative elements.

8. A comparison engine for determining item similarity, the comparison engine comprising:
one or more hardware processors;
a triplet-trained machine learning model executable by the one or more hardware processors and trained using training data including triplets of anchor elements, positive elements, and negative elements, wherein each triplet corresponds to an item included in the training data, the anchor elements and the positive elements are included in the corresponding item, and the negative element is included in a different item in the training data;
an input interface executable by the one or more hardware processors and configured to input a source item and one or more candidate items into the triplet-trained machine learning model; and
a similarity score generator executable by the one or more hardware processors and configured to generate from the triplet-trained machine learning model a similarity score between the source item and each of the one or more candidate items.

9. The comparison engine of claim 8, wherein the triplet-trained machine learning model is trained based on a masked language model loss function during training using the training data.

10. The comparison engine of claim 8, wherein the triplet-trained machine learning model is trained based on a combination of a masked language model loss function and a metric-based loss function during training using the training data.

11. The comparison engine of claim 8, wherein the triplet-trained machine learning model is trained based on a metric-based loss function during training using the training data.

12. The comparison engine of claim 11, wherein the metric-based loss function is based on an angular distance between an embedded anchor element vector and an embedded positive element vector.

13. The comparison engine of claim 11, wherein the metric-based loss function is based on an angular distance between an embedded anchor element vector and an embedded negative element vector.

14. The comparison engine of claim 11, wherein the metric-based loss function is based on an angular distance between an embedded anchor element vector and an embedded negative element vector subtracted from an angular distance between the embedded anchor element vector and an embedded positive element vector.

15. One or more tangible processor-readable storage media of a tangible article of manufacture encoding processor-executable instructions for executing a computing process for determining item similarity, the computing process comprising:
inputting a source item and one or more candidate items into a triplet-trained machine learning model trained using training data including triplets of anchor elements, positive elements, and negative elements, wherein each triplet corresponds to an item included in the training data, the anchor elements and the positive elements are included in the corresponding item, and the negative element is included in a different item in the training data; and
generating from the triplet-trained machine learning model a similarity score between the source item and each of the one or more candidate items.

16. The one or more tangible processor-readable storage media of claim 15, wherein the triplet-trained machine learning model is trained based on a combination of a masked language model loss function and a metric-based loss function during training using the training data.

17. The one or more tangible processor-readable storage media of claim 15, wherein the triplet-trained machine learning model is trained based on a metric-based loss function during training using the training data.

18. The one or more tangible processor-readable storage media of claim 17, wherein the metric-based loss function is based on an angular distance between an embedded anchor element vector and an embedded positive element vector.

19. The one or more tangible processor-readable storage media of claim 17, wherein the metric-based loss function is based on an angular distance between an embedded anchor element vector and an embedded negative element vector.

20. The one or more tangible processor-readable storage media of claim 17, wherein the metric-based loss function is based on an angular distance between an embedded anchor element vector and an embedded negative element vector subtracted from an angular distance between the embedded anchor element vector and an embedded positive element vector.
